(19) United States
(12) Patent Application Publication
(10) Pub. No.: US 2013/0316433 A1
(43) Pub. Date: Nov. 28, 2013

(54) ENZYME COMPOSITION AND METHODS TO TRANSFORM PERFLUOROALKYL COMPOUNDS IN SOIL AND/OR GROUNDWATER

(71) Applicant: QINGGUO HUANG, FAYETTEVILLE, GA (US)

(72) Inventor: QINGGUO HUANG, FAYETTEVILLE, GA (US)

(21) Appl. No.: 13/899,871

(22) Filed: May 22, 2013

Related U.S. Application Data
(60) Provisional application No. 61/650,075, filed on May 22, 2012.

(51) Int. Cl. B09C 1/10; B09C 1/00

(52) U.S. Cl. CPC B09C 1/10; B09C 1/002
USPC 435/192; 210/632; 210/170.07; 405/264; 435/189

(57) ABSTRACT

The present disclosure provides systems and methods for at least partially remediating soil and/or groundwater containing perfluroroalkyl compounds (PFCs). In some embodiments, the systems and methods utilize an oxidase such as laccase, optionally with one or more enzyme-catalyzed oxidative humification reaction (ECOHR) mediators. In some embodiments the method is an in situ method. Optionally, the oxidase can be immobilized on soil, sand, clay, and/or activated carbon.

This application claims the benefit of U.S. Provisional Application No. 61/650,075, filed May 22, 2012, which is incorporated herein by reference in its entirety.

### GOVERNMENT FUNDING

The present invention was made with government support under Grant No. ER2127, W912HQ-11-C-0022, awarded by the Strategic Environmental Research and Development Program (SERDP). The government has certain rights in this invention.

### BACKGROUND

Perfluoroalkyl compounds (PFCs), such as perfluorooctane sulfonic acid (PFOS) and perfluorooctanoic acid (PFOA), have extremely high thermal and chemical stability, stemming from their unique structural features in which all hydrogens on carbon are replaced with fluorines. The carbon-fluorine bond is strong because fluorine has strong electronegativity that induces a partial positive charge on carbon and a negative charge on fluorine atoms, leading to electrostatic attraction that makes the bond shorter and stronger. Fluorine is the most electronegative element having a reduction potential of 3.6 V. Thus, oxidative replacement of the fluorine atom with any other atom is thermodynamically unfavorable. In addition, the fluorine atoms, which are much larger than hydrogen in size, form a dense hydrophobic layer in PFOX (X═S or X=A) surrounding carbon-carbon bonds, which shields them from attack by oxidative reagents. The oxidation resistance prevents PFCs from being oxidized under normal conditions and from being utilized by microbes as carbon and energy sources, making these chemicals extremely persistent in the environment.

PFOA and PFOS in groundwater can be removed by ex situ liquid phase granular activated carbon (GAC). However, the high stability of PFCs limits the effectiveness of current in situ treatment technologies involving oxidation and microbial degradation for degrading PFCs. Advanced oxidation processes (AOPs), such as alkaline ozonation, peroxone, or Fenton's reagent, have been shown to be effective to degrade a wide range of organic contaminants The degradation largely relies on the oxidative power of hydroxyl radicals generated during these processes. Hydroxyl radicals normally react with saturated organics through an H-atom abstraction, or react with unsaturated organics via an oxidative addition reaction. However, PFCs have no hydrogen available for abstraction, or a double bond for addition, i on, leaving direct electron transfer as the only possible pathway, which is unfortunately less potent. Thus, the perfluorination in PFC renders these compounds essentially inert to these advanced oxidation techniques. Direct and indirect photolytic oxidation pathways, sonochemistry, and reductive dehalogenation have been shown to be effective for PFC degradation; however none are suitable for in situ treatment applications.

Thus, there remains a need for new methods for remediation of PFCs.

### SUMMARY

In one embodiment, the present disclosure provides an in situ method for at least partially remediating soil and/or groundwater containing perfluroroalkyl compounds (PFCs). The method includes amending an effective amount of one or more catalysts that mediate enzyme-catalyzed oxidative humification reactions (ECOHRs) into the soil and/or groundwater. The perfluroroalkyl compounds (PFCs) can include perfluorocarboxylic acids (e.g., perfluorooctanoic acid, PFOA), perfluorosulfonic acids (e.g., perfluorooctane sulfonic acid, PFOS), polyfluorinated telomers, or combinations thereof. The one or more catalysts that mediate enzyme-catalyzed oxidative humification reactions (ECOHRs) can include laccase, horseradish peroxidase, lignin peroxidase, manganese peroxidase, a manganese oxide, an iron oxide, or combinations thereof. The method can further include amending an effective amount of one or more cofactors (e.g., a source for hydrogen peroxide and/or oxygen such as calcium peroxide) into the soil and/or groundwater. The method can optionally include amending an effective amount of one or more enzyme-catalyzed oxidative humification reaction (ECOHR) mediators into the soil and/or groundwater. Suitable enzyme-catalyzed oxidative humification reaction (ECOHR) mediators include, for example, violuric acid (VA), 2,2′-azino-bis(3-ethylbenzothiazoline-6-sulphonic acid (ABTS), 1-hydroxybenzotriazole (HBT), 2,4-dimethoxyphenol, 4-methoxyphenol, guaiacol, catechol, or combinations thereof. Optionally, the one or more catalysts can be immobilized on soil, sand, clay, and/or activated carbon.

In another embodiment, the present disclosure provides a method for at least partially remediating soil and/or groundwater containing perfluroroalkyl compounds (PFCs). The method includes amending an effective amount of an oxidase (e.g., laccase) into the soil and/or groundwater. The perfluroroalkyl compounds (PFCs) can include perfluorocarboxylic acids (e.g., perfluorooctanoic acid, PFOA), perfluorosulfonic acids (e.g., perfluorooctane sulfonic acid, PFOS), polyfluorinated telomers, or combinations thereof. The method can further include amending an effective amount of one or more enzyme-catalyzed oxidative humification reaction (ECOHR) mediators into the soil and/or groundwater. Suitable enzyme-catalyzed oxidative humification reaction (ECOHR) mediators include, for example, violuric acid (VA), 2,2′-azino-bis(3-ethylbenzothiazoline-6-sulphonic acid (ABTS), 1-hydroxybenzotriazole (HBT), 2,4-dimethoxyphenol, 4-methoxyphenol, guaiacol, catechol, or combinations thereof. In some embodiments the method is an in situ method. In some embodiments the method is an ex situ method. Optionally, the oxidase can be immobilized on soil, sand, clay, and/or activated carbon.

In another embodiment, the present disclosure provides a method for at least partially remediating soil and/or groundwater containing perfluroroalkyl compounds (PFCs). The method includes amending into the soil and/or groundwater, components including: an effective amount of one or more catalysts that mediate enzyme-catalyzed oxidative humification reactions (ECOHRs); and an effective amount of one or more enzyme-catalyzed oxidative humification reaction (ECOHR) mediators selected from the group consisting of violuric acid (VA), 2,2′-azino-bis(3-ethylbenzothiazoline-6-sulphonic acid (ABTS), 1-hydroxybenzotriazole (HBT), 2,4-dimethoxyphenol, 4-methoxyphenol, guaiacol, and catechol. The perfluroroalkyl compounds (PFCs) can include perfluorocarboxylic acids (e.g., perfluorooctanoic acid, PFOA), perfluorosulfonic acids (e.g., perfluorooctane sulfonic acid, PFOS), polyfluorinated telomers, or combinations thereof. The one or more catalysts that mediate enzyme-catalyzed oxidative humification reactions (ECOHRs) can include laccase, horseradish peroxidase, lignin peroxidase, manganese peroxidase, a manganese oxide, an iron oxide, or combinations thereof. Optionally, the method can further include amending an effective amount of one or more sources for hydrogen peroxide and/or oxygen into the soil and/or groundwater. In some embodiments, the method is an in situ method. In some embodiments the method is an ex situ method. Optionally, the one or more catalysts can be immobilized on soil, sand, clay, and/or activated carbon.

In another embodiment, the present disclosure provides a composition including one or more catalysts that mediate enzyme-catalyzed oxidative humification reactions (ECOHRs) immobilized on soil, sand, clay, and/or activated carbon. The one or more catalysts that mediate enzyme-catalyzed oxidative humification reactions (ECOHRs) can include laccase, horseradish peroxidase, lignin peroxidase, manganese peroxidase, a manganese oxide, an iron oxide, or combinations thereof. In some embodiments, the one or more catalysts are immobilized utilizing adsorption, electrostatic interactions, and/or covalent bonding.

In another embodiment, the present disclosure provides a system for at least partially remediating soil and/or groundwater containing perfluroroalkyl compounds (PFCs). The system includes at least a first layer of an enzyme-catalyzed oxidative humification reaction (ECOHR) barrier including an effective amount of one or more catalysts that mediate enzyme-catalyzed oxidative humification reactions (ECOHRs) immobilized on soil, sand, clay, and/or activated carbon. Optionally, the system can further include a second layer having an effective amount of an oxidant-releasing material layer, or the oxygen-releasing material can be mixed in the enzyme-catalyzed oxidative humification reaction (ECOHR) barrier.

In some embodiments, the methods and systems disclosed herein can be advantageous for in situ methods for at least partially remediating soil and/or groundwater containing perfluroroalkyl compounds (PFCs). The methods and systems disclosed herein can involve only environmentally friendly materials, e.g. enzymes, naturally occurring compounds and materials, and activated carbon. The methods and systems disclosed herein may not require excessive energy inputs or specialized equipment to operate. The methods can render perfluroroalkyl compounds (PFCs) partially degraded to smaller molecules that are likely less toxic and more readily degradable by microbes. Thus, the methods can be used alone or in combination with other treatment approaches in a treatment chain to achieve complete removal of perfluroroalkyl compounds (PFCs). The methods are also applicable for treatment of perfluroroalkyl compounds (PFCs) in an ex situ setup.

### Definitions

The terms “comprises” and variations thereof do not have a limiting meaning where these terms appear in the description and claims.

As used herein, “a,” “an,” “the,” “at least one,” and “one or more” are used interchangeably.

As used herein, an “effective amount” of a component is an amount that will result in the at least partial remediation of soil and/or groundwater containing perfluoroalkyl compounds (PFCs) over a desired time. Specific amounts will depend on specific environmental factors including, but not limited to, type and property of soil or geological materials, pH of soil, redox potential, amount and flow rate of groundwater, temperature, the duration of treatment, amounts and types of PFCs and other contaminants in the soil and/or groundwater, the types of catalysts that are used, singularly or in combination, the types of mediators are used, singularly or in combination, and the means by which the catalysts, mediators or oxidant to be amended to the soil or groundwater, but will be apparent to one of skill in the art in view of the guidance provided in the detailed description and working examples disclosed herein. As an example to provide a general guidance for the ranges of catalysts, mediators, and oxidants, a system with laccase as the catalyst, 1-hydroxybenzotriazole (HBT) as the mediator, and oxygen as oxidant can cause effective PFCs degradation in soil in 45 days when laccase activity is 1 to 1000 units/g of soil, 1-hydroxybenzotriazole (HBT) concentration at 0 to 100 micromole/g soil, oxygen at the natural level. Oxygen can be amended by adding calcium peroxide or other peroxides materials or by purging air or oxygen gas, which will enhance the enzyme catalyzed oxidative humification reactions (ECOHRs) and PFCs degradation. Enzymes and mediators can be added to soils by soil blending/mixing or to ground water by direct injection. Alternatively, enzymes and mediators can be immobilized to a support material (e.g., activated carbon) and packed into a column for ex situ treatment use or filled into a trench to form a permeable reactive barrier to cut off a groundwater plume containing PFCs. It is noted that soil organic matter itself can serve the role of mediator for enzyme catalyzed oxidative humification reactions (ECOHRs), and thus, the system can be effective when a mediator is not added to the system. Here one unit of laccase activity is defined as the amount of enzyme that causes a unit change per minute in absorbance at 468 nm in 3 4 mL of a solution in a cuvette with 1 cm light path containing 1 mM 2,6-dimethoxyphenol in a pH 3.8 citrate phosphate buffer.

Also herein, the recitations of numerical ranges by endpoints include all numbers subsumed within that range (e.g., 1 to 5 includes 1, 1.5, 2, 2.75, 3, 3.80, 4, 5, etc.).

The above brief description of various embodiments of the present invention is not intended to describe each embodiment or every implementation of the present invention. Rather, a more complete understanding of the invention will become apparent and appreciated by reference to the following description and claims in view of the accompanying drawings. Further, it is to be understood that other embodiments may be utilized and structural changes may be made without departing from the scope of the present invention.

### BRIEF DESCRIPTION OF THE DRAWINGS

FIG. 1 is a schematic illustration of one embodiment of a two-layer barrier for a column study.

FIG. 2 is a graphical illustration of normalized perfluorooctanoic acid (PFOA) concentration, 4-methoxyphenol concentration, and laccase activity as a function of time in the aqueous phase. The starting concentrations were 0.83 μM PFOA for all treatments, the laccase activity and 4-methoxyphenol concentrations were A: 0.3 unit/mL laccase and 20 μM 4-methoxyphenol; B: 0.3 unit/mL laccase and 200 μM 4-methoxyphenol; C: 0.3 unit/mL laccase and 2,000 μM 4-methoxyphenol; and D: 10 unit/mL laccase and 200 μM 4-methoxyphenol.

FIG. 3 is a graphical illustration showing PFOA recovery (%) after 7, 15, and 45 days of incubation. Each reactor contained 1 g soil preloaded with 10 μg PFOA in 1.5 mL water. Laccase was added every 48 hours at 2 units/g soil, and the mediator (HBT, VA, or ABTS) was added along with laccase. Equal amounts of mediator were added each time, and the total amount added was 8 μmoles/g soil. Values illustrated are the means of three replicates, and error bars represent standard deviations.

FIG. 4 is a graphical illustration showing PFOA recovery (%) after 15 days of treatment. Each reactor contained 1 g soil preloaded with 10 μg PFOA in 1.5 mL water. Laccase was added every 48 hours at 2 units/g soil, and the mediator (HBT, VA, or ABTS) was added along with laccase. Equal amounts of mediator were added each time, and the total amount added was 4 or 8 μmole/g soil. Values illustrated are the means of three replicates, and error bars represent standard deviations.

FIG. 5 is a graphical illustration showing PFOS recovery (%) after 15 days of incubation. Each reactor contained 1 g soil preloaded with 5 μg PFOS in 1.5 mL water. Laccase was added every 48 hours at 2 units/g soil, and the mediator (HBT, VA, or ABTS) was added along with laccase. Equal amounts of mediator were added each time, and the total amount added was 8 μmole/g soil. Values illustrated are the means of three replicates, and error bars represent standard deviations.

FIG. 6 is a graphical illustration showing activity of horseradish peroxidase (HRP) immobilized on sand via layer-by-layer assembly of negatively charged poly (sodium 4-styrenesulfonate) and HRP of various concentrations in pH 6.0 buffer solution that rendered laccase positively charged.

FIG. 7 is a graphical illustration showing activity of horseradish peroxidase (HRP) immobilized on sand via layer-by-layer assembly of negatively charged poly (sodium 4-styrenesulfonate) and 2.0 mg/mL HRP in buffer solutions of varying pH that rendered HRP positively charged.

FIG. 8 is a graphical illustration showing activity of horseradish peroxidase (HRP) immobilized on sand via layer-by-layer assembly of negatively charged poly(sodium 4-styrenesulfonate) and 10 mg/mL laccase in buffer solutions of varying pH that rendered the laccase positively charged.

FIG. 9 is a graphical illustration showing activity of laccase immobilized on sand via covalent bonding under different pH and temperatures using a 10 mg/mL laccase solution.

FIG. 10 is a graphical illustration showing residual activity of immobilized laccase after multiple reaction cycles with 2,6-dimethoxyphenol as the substrate.

FIG. 11 is a graphical illustration showing activity of laccase immobilized on a sandy loam soil and a clay through covalent bonding under pH 3.8 and 7.0.

FIG. 12 is a graphical illustration showing the change of the activity of immobilized laccase on a sandy loam soil and a clay over 21 days of storage at 4° C.

FIG. 13 is a graphical illustration showing the sorption isotherm of laccase on granular activated carbon at 25° C.

FIG. 14 is a schematic illustration of an embodiment of a model of an ECOHR barrier.

FIG. 15 is a schematic illustration of the setup of a column flow-through experiment utilizing a micro-column packed with granular activated carbon.

FIG. 16 is a graphical illustration showing the sorption isotherms of 4-methoxyphenol, catechol, guaiacol, and HBT on granular activated carbon (GAC) at 25° C.

FIG. 17 is a graphical illustration showing the sorption isotherm of PFOA on GAC at 25° C.

FIG. 18 is a graphical illustration showing breakthrough of a laccase solution (1.0 unit/mL) on a GAC (0.1 g) packed micro-column.

FIG. 19 is a graphical illustration showing breakthrough of PFOA on a GAC packed micro-column with ECHOR reaction induced and a blank GAC column. Both columns were packed with 0.1 g GAC, and the reaction column was preloaded with laccase by passing through 42 mL of 1 unit/mL laccase solution at 0.1 mL/minute. The feed solution for the reaction column contained 0.067 mg/L PFOA, 0.15 mM of HBT, and 1 unit/mL laccase, while that for the blank column contained only 0.067 mg/L PFOA. The feed solution was operated at 2 mL/minute.

### DETAILED DESCRIPTION OF ILLUSTRATIVE EMBODIMENTS

An earlier study disclosed that PFOA can be effectively degraded under specific conditions during enzyme-catalyzed oxidative humification reactions (ECOHRs) (Colosi et al., Environmental Toxicology and Chemistry (2009) 28:264-271). ECOHR refers to a class of oxidative reactions critically involved in natural organic matter (NOM) humification processes. These reactions are ubiquitous in soil systems, and usually catalyzed by certain naturally occurring extracellular enzymes that are produced by certain white/brown rot fungi, including lignin peroxidase, manganese peroxidase and laccases, etc. (Bollag, Metal Ions in Biological Systems (1992) 28:205-217; and Dec et al., J. Environ. Qual. (2000) 29:665-676). These enzymes can effectively catalyze conversion of natural or anthropogenic chemicals containing phenolic or anilinic moieties into active intermediates such as radicals or quinones that can subsequently be bound covalently into NOM (Colosi et al., Environmental Toxicology and Chemistry (2009) 28:264-271; Huang et al., Environmental Science & Technology (2004) 38:5238-5245; Huang et al., Environmental Science & Technology (2004) 38:338-344; Park et al., Environmental Science & Technology (1999) 33:2028-2034; and Weber et al., Environmental Science & Technology (2003) 37:4221-4227). Such active intermediates may also fortuitously attack other inert chemicals, such as lignin, and thus cause their degradation and consequently incorporate them into the natural humification process. We have shown in our earlier studies that such mediator-facilitated mechanism can lead to degradation of PFCs (Colosi et al., Environmental Toxicology and Chemistry (2009) 28:264-271), PAHs (Weber et al., Environmental Science & Technology (2003) 37:4221-4227), and PCBs (Colosi et al., Environmental Science & Technology (2007) 41:891-896) during ECOHR. A number of naturally occurring chemicals, such as 4-methoxyphenol, guaiacol, catechol, and even soil organic matter itself can serve as such mediators by generating free radicals under humification enzyme catalysis (Colosi et al., Environmental Science & Technology (2007) 41:891-896 ; Colosi et al., Environmental Toxicology and Chemistry (2009) 28:264-271; and Weber et al., Environmental Science & Technology (2003) 37:4221-4227). There are two classes of enzymes that are able to catalyze ECOHR, including certain peroxidases, such as lignin peroxidase (LiP, EC 1.11.1.14), manganese peroxidase (MnP, EC 1.11.1.13) and horseradish peroxidase (HRP, EC 1.11.1.7), and some phenol oxidases, such as laccase (E.C. 1.10.3.2). Peroxidases can catalyze the oxidation of phenolic chemicals into free radicals in the presence of hydrogen peroxide, while phenol oxidases carry out phenol oxidation in the presence of oxygen.

In a previous study (Colosi et al., Environmental Toxicology and Chemistry (2009) 28:264-271), PFOA degradation was observed during ECOHR mediated by horseradish peroxidase (HRP) in the presence of 4-methoxyphenol as a co-substrate under room temperature and at a neutral pH. Such reactions did not occur in the absence of the 4-methoxyphenol, suggesting that HRP's interaction with 4-methoxyphenol as a mediator resulted in PFOA degradation. Based on the products pattern, we postulated that the phenoxyl radicals formed during HRP oxidation of 4-methoxyphenol fortuitously attacked PFOA, likely initiated by abstracting an electron from the head C—C bond on PFOA, leading to its breakdown. It is not fully clear yet why phenoxyl radicals appear to be more effective in transforming PFOA than hydroxyl radicals generated in advanced oxidation processes (AOPs), but it may be related to the longer life time of phenoxyl radicals and its relative hydrophobicity. The PFC molecules contain a dense hydrophobic outer layer of fluorine atoms that shield C—C bonds. The hydrophobic phenoxyl radicals may be more amenable than hydrophilic hydroxyl radicals to approach the C—C bonds and initiate PFC breakdown.

The findings described above suggest that PFCs may be transformed in the natural environment through humification, although such natural process are impractical for treatment of remediation, given the low concentration of PFCs and the low dosages of humification enzymes in the natural environment. The approach disclosed herein involves inducing enzyme-catalyzed oxidative humification reactions (ECOHRs) in situ or ex situ in soil/groundwater containing perfluroroalkyl compounds (PFCs) by amendment of catalysts mediating ECOHR reactions, such as laccase, horseradish peroxidase, lignin peroxidase, and manganese peroxidase. Some minerals, such as manganese and iron oxides may also catalyze similar reactions. Laccase is regarded as a practical candidate for application because it is widely available and is stable in soil; alternatively, certain fungi, e.g. white rot fungus, that produce humification enzymes may also be cultured in situ to produce the enzymes. In some embodiments, cofactors (e.g., hydrogen peroxide for peroxidases or oxygen for laccase) and/or ECOHR mediators can be included in the mixture. For example, calcium peroxide can be added to slowly release oxygen and hydrogen peroxide. In some embodiments, co-factors may be abundantly available naturally. Humic monomers may be naturally available as ECOHR mediators.

As further described herein, humification reactions of PFCs can be enhanced through engineering approaches for treatment or remediation applications. As disclosed herein, enzyme catalyzed oxidative humification reactions (ECOHRs) can be induced in situ or ex situ by providing catalysts, mediators, and oxidants in appropriate forms, combinations, and amounts to induce effective ECOHR for treatment of PFCs.

One embodiment of such a system is a permeable reactive barrier system for in situ or ex situ treatment of flows containing PFCs. The systems can be constructed by immobilizing humification enzymes on one or multiple solid support materials (e.g. activated carbon, soil, clay) and packed them into a permeable reactive barrier for in situ remediation use or into a column for ex situ treatment use. ECOHR mediators can be immobilized on the support material as well or added in the flow. Humification enzymes can also be added to the flow to further enhance the reactivity. Oxidant in the form of oxygen or hydrogen peroxide can be used at their natural levels or supplemented by mixing peroxide materials (e.g. calcium peroxide, hydrogen peroxide) into the support materials or flow or by purging air or oxygen into the flow.

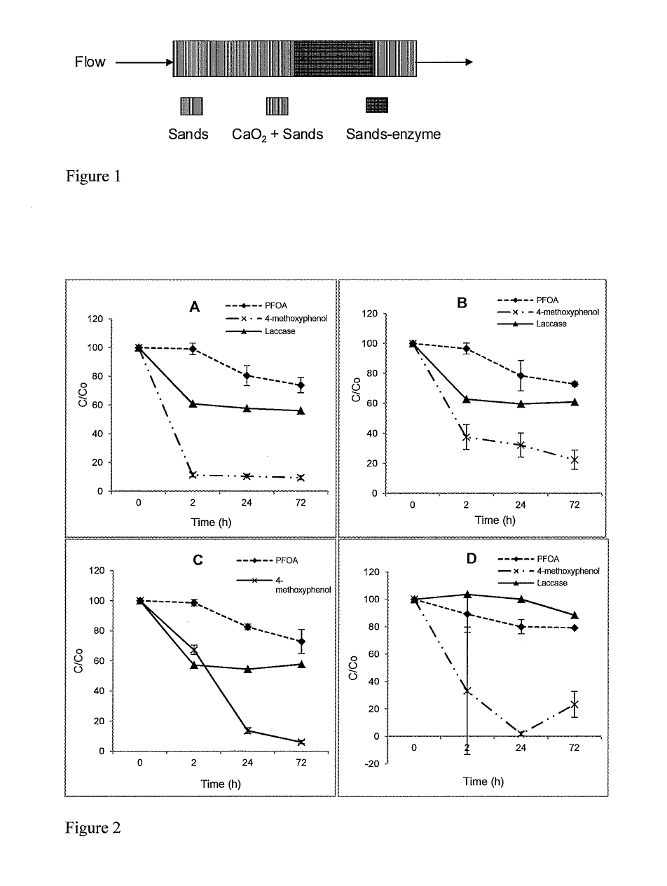

Another embodiment of such a system, a double-layer permeable reactive barrier (DL-PRB) system for inducing in situ ECOHR, is illustrated in FIG. 1. The DL-PRB includes an oxidant-releasing material layer followed by a layer of quartz sands immobilized with humification enzymes. The oxidant-releasing material layer, which contains calcium peroxide, continuously releases oxidants (oxygen and hydrogen peroxide) upon contact with water, which feeds into the humification enzyme layer where humification processes are facilitated to result in concomitant transformation of PFCs.

Another embodiment of such a system involves amendment of the humification enzymes and mediators into soil by soil blending or mixing to induce ECOHR in situ. Oxygen may be added to enhance the reactions via adding calcium peroxide or purging air or oxygen into soil.

Another embodiment of such a system involves amendment of the humification enzymes and mediators into groundwater via direct injection to induce ECHOR in situ. Oxygen may be added to enhance the reactions via adding calcium peroxide or purging air or oxygen into soil.

Another embodiment of such a system involves adding humification catalysts, mediators, and/or oxidants into existing products, solutions, or formulas (e.g., aqueous film-forming foams (AFFF)) that contain PFCs, as a method to transform PFCs prior to their disposal.

The following examples are offered to further illustrate various specific embodiments and techniques of the present disclosure. It should be understood, however, that many variations and modifications understood by those of ordinary skill in the art may be made while remaining within the scope of the present disclosure. Therefore, the scope of the disclosure is not intended to be limited by the following examples.

### EXAMPLES

### Example 1

### Batch Reactor System: Aqueous Phase

A series of experiments to examine PFOA degradation during ECOHR in aqueous phase under various combinations of different conditions was conducted, including three different enzymes (HRP, LiP, and Laccase) at different dosages, five different mediators (guaiacol, catechol, HBT, veratryl alcohol, and 4-methoxyphenol) at different concentrations, and different initial PFOA concentrations. The goal was to verify PFOA degradation in different ECOHR systems and explore the range of effective conditions.

HRP activity was assayed by measuring the color change of ABTS. In this method 0.05 mL of enzyme sample was added to a 3 mL of reaction mixture containing 2 mM ABTS in phosphate buffer (pH 6). This was followed by addition of 0.3 mL of 10 mM H₂O₂ to the mixture and was immediately taken to UV/Vis spectrophotometer at 405 nm. One unit of peroxidase activity is defined as the amount catalyzing the oxidation of one μmol of ABTS per minute.

For LiP activity measurement, 400 μL enzyme solution was added to a cell containing 400 μL tartarate buffer solution (pH 3), followed by addition of 200 μL 10 mM veratryl alcohol and 200 μL, 2 mM H₂O₂ to start the assay. Absorbance was recorded at 310 nm every 15 seconds for a period of 1 minute on a Du 640-B spectrophotometer (Beckman Instruments, Inc.). One activity unit of LiP corresponds to the amount of enzyme that catalyzes the oxidation of 1 μmol veratryl alcohol per minute.

Laccase activity was determined spectrometrically by oxidation of 1 mM 2,6-dimethoxyphenol in citrate phosphate buffer (pH 3.8), the absorbance of which was measured at 468 nm (Beckman Du 640-B spectrophotometer, Beckman Instruments Inc.). One unit of laccase activity is defined as the amount of enzyme that causes a unit change per minute in absorbance at 468 nm in 3.4 mL of this solution in cuvette with 1 cm light path.

The experiments examining ECOHR in aqueous phase were carried out at room temperature in test tubes, each containing 5 mL solution having PFOA, a mediator, and a humification enzyme, all at systematically varied concentrations. When peroxidases were used, hydrogen peroxide was also included in the solution and was added last to start the reaction. Each condition was tested in triplicate. Systems without enzyme or a mediator added were also tested for comparison. The test tubes were capped and incubated for pre-determined times with agitation. At the end of incubation, 0.5 mL of the reaction solution was withdrawn from the reactor and mixed with 0.5 mL methanol to terminate the reaction, and the mixture was used for LC-MS/MS analysis to quantify PFOA.

Quantification of PFOA was performed on a Waters Micromass Quattra tandem mass spectrometer (Waters, Milford, Mass.) interfaced with a Waters 2690 HPLC system (Waters, Milford, Mass.). The separation was performed on an Ascentic C18 reversed phase column (25×4 mm, Supelco, St. Louis, Mo.). A binary gradient elution consisting of 2 mM ammonium acetate solution in deionized water (A) and acetonitrile (B) at a flow rate of 0.3 mL/minute was used as mobile phase for PFOA quantification. The injection volume was 10 μL. The gradient spanned 30 minutes and was programmed as follows: 40% B was increased linearly to 80% at 5 minutes, 90% at 10 minutes, held at 90% B for additional 15 minutes and finally decreased to 40% B. The electrospray ionization in a negative mode was used for both PFOA and PFOS detection with the following parameters: capillary voltage was set to 3.01 V, desolvation temperature to 300° C., and source block temperature to 100° C. For PFOA, cone voltage set to 20 V and collision energy at 20 eV, while for PFOS cone voltage and collision energy were set at 67 V and 38 eV respectively. Nitrogen (Airgas, >99.999% purity) was used as nebulizer and drying gas and gas flow rates were maintained at 34 and 198 L/hour, respectively. PFOA was quantified by multiple reaction monitoring (MRM) using the most abundant precursor/product (m/z) ion transition (413→369 for PFOA). External five point calibration curves for this method were generated using standard PFOA concentrations ranging from 0.01 mg/L to 10 mg/L.

The experimental results from aqueous phase reactions are summarized in Table 1. PFOA removal percentage was calculated by comparing the reaction sample with the control sample which was prepared the same as the reaction sample except for the absence of enzyme. A couple observations can be made. First, all three tested enzymes can cause PFOA removal under certain conditions, as seen in the systems 13 and 14 for HRP, 16-18 for LiP, and 22-54 for laccase. Second, when the initial PFOA concentration was above 100 μM, no significant PFOA concentration reduction was observed, as shown in the systems 1-12 and 55-57. Third, the best PFOA removal percentage was nearly 30% (systems 27, 41, 53 etc.), and increase of enzyme dosage (e.g., systems 23, 35, and 41) or mediator concentration (e.g., systems 22-24) did not significantly enhance PFOA removal. This suggests that a factor other than enzyme dosage or mediator concentration may have limited the extent of PFOA removal in the tested reaction systems.

TABLE 1
PFOA removal under various ECOHR conditions in aqueous phase

| | PFOA | | | E | M | Reaction | | |
|---|---|---|---|---|---|---|---|---|
| | Con. | Enzyme | Mediator | dosage | dosage | Time | Removal | standard |
| No. | (μM) | Type | Type | (U/mL) | (μM) | (hours) | (%) | deviation |
| 1 | 100 | HRP¹ | Guaiacol | 0.015 | 10 | 1 | 0.02 | 0.43 |
| 2 | | | | | 100 | | 0.30 | 1.08 |
| 3 | | | | | 1,000 | | 2.00 | 0.16 |
| 4 | | | | | 10,000 | | −0.35 | 0.34 |
| 5 | | | Catechol | 0.015 | 10 | 1 | 2.10 | 0.59 |
| 6 | | | | | 100 | | 6.10 | 0.58 |
| 7 | | | | | 1,000 | | 1.10 | 0.13 |
| 8 | | | | | 10,000 | | 6.98 | 4.07 |
| 9 | | | HBT | 0.015 | 10 | 1 | 3.40 | 0.28 |
| 10 | | | | | 100 | | 3.50 | 0.41 |
| 11 | | | | | 1,000 | | 2.00 | 0.04 |
| 12 | | | | | 10,000 | | 5.40 | 6.39 |
| 13 | 24 | HRP¹ | 4-methoxy- | 0.02 | 210 | 2 | 12.10 | 2.55 |
| 14 | | | phenol | 0.1 | 210 | | 19.73 | 7.82 |
| 15 | 30 | LiP² | Veratryl | 0.005 | 0 | 1 | 3.70 | — |
| 16 | | | alcohol | | 200 | | 23.10 | — |
| 17 | | | | 0.025 | 0 | | 18.20 | — |
| 18 | | | | | 200 | | 19.20 | — |
| 19 | 1 | Laccase³ | 4-methoxy- | 0.3 | 20 | 2 | 0.97 | 4.03 |
| 20 | | | phenol | | 200 | | 3.49 | 3.73 |
| 21 | | | | | 2,000 | | 1.41 | 2.10 |
| 22 | | | | | 20 | 24 | 19.53 | 7.00 |
| 23 | | | | | 200 | | 21.56 | 10.14 |
| 24 | | | | | 2,000 | | 17.48 | 1.84 |
| 25 | | | | | 20 | 72 | 26.20 | 5.30 |
| 26 | | | | | 200 | | 27.20 | 1.46 |
| 27 | | | | | 2,000 | | 27.10 | 7.97 |
| 28 | | | | | 20 | 120⁴ | 21.64 | 1.05 |
| 29 | | | | | 200 | | 20.46 | 10.23 |
| 30 | | | | | 2,000 | | 21.44 | 0.72 |
| 31 | | | | 1 | 20 | 2 | 11.07 | 5.68 |
| 32 | | | | | 200 | | 12.45 | 1.82 |
| 33 | | | | | 2,000 | | 6.13 | 4.63 |
| 34 | | | | | 20 | 24 | 10.87 | 0.00 |
| 35 | | | | | 200 | | 8.62 | 3.49 |
| 36 | | | | | 2,000 | | 12.48 | 12.62 |
| 37 | | | | | 20 | 72 | 23.60 | 4.80 |
| 38 | | | | | 200 | | 16.40 | 19.02 |
| 39 | | | | | 2,000 | | 11.30 | 8.13 |
| 40 | | | | | 20 | 120⁴ | 27.06 | 3.89 |
| 41 | | | | | 200 | | 21.53 | 2.76 |
| 42 | | | | | 2,000 | | 19.82 | 0.28 |
| 43 | | | | 10 | 20 | 2 | 9.86 | 6.21 |
| 44 | | | | | 200 | | 10.80 | 13.29 |
| 45 | | | | | 2,000 | | 5.90 | 0.59 |
| 46 | | | | | 20 | 24 | 22.69 | 4.13 |
| 47 | | | | | 200 | | 20.00 | 5.21 |
| 48 | | | | | 2,000 | | 19.60 | 0.67 |
| 49 | | | | | 20 | 72 | 6.00 | 5.89 |
| 50 | | | | | 200 | | 20.80 | 0.36 |
| 51 | | | | | 2,000 | | 9.40 | 2.21 |
| 52 | | | | | 20 | 120⁴ | 27.32 | 0.96 |
| 53 | | | | | 200 | | 30.43 | 0.67 |
| 54 | | | | | 2,000 | | 17.54 | 0.09 |
| 55 | 1,000 | Laccase³ | 4-methoxy- | 10 | 20 | 24 | 5.17 | 1.17 |
| 56 | | | phenol | | 200 | | −4.60 | 10.09 |
| 57 | | | | | 2,000 | | −14.67 | 3.74 |

¹H₂O₂ concentration is 150 μM for all horseradish peroxidase (HRP) reaction.
²H₂O₂ concentration is 100 μM for all lignin peroxidase (LiP) reaction.
³The O₂ required for laccase reaction was naturally dissolved oxygen.
⁴The mediator was added at the designated dosage once at time 0 and once at 72 hours.

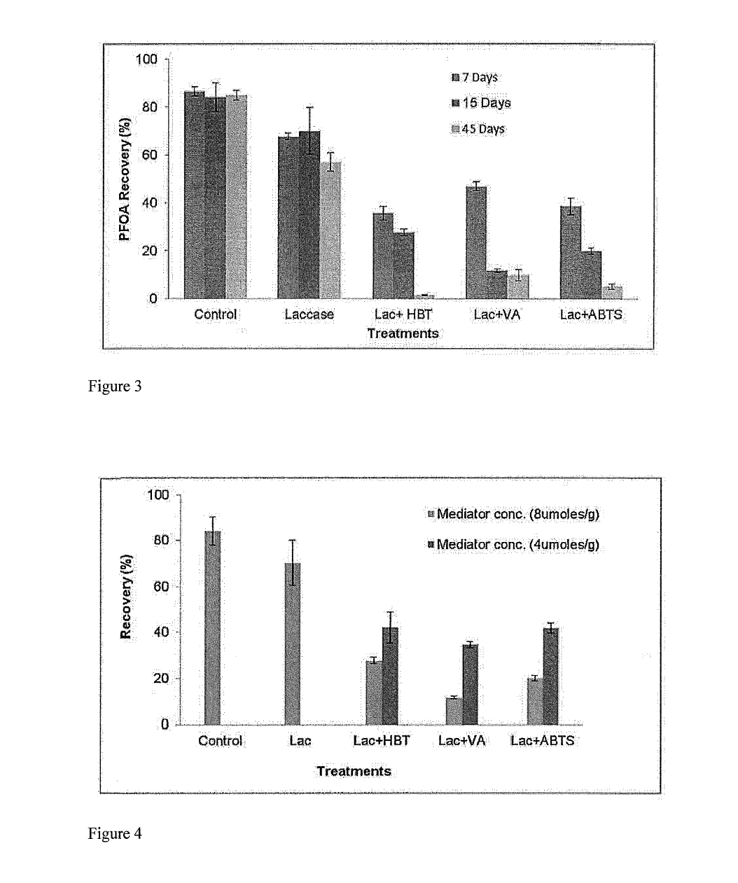

Because all three tested enzymes exhibited the capability of mediating ECOHR to cause PFOA degradation, laccase was identified as a promising candidate for potential remediation use based on knowledge of the humification enzymes and experiment results from other related research. First, laccase is highly stable, retaining high enzyme activity during ECOHR. All humification enzymes undergo inactivation during ECOHR via certain suicidal mechanisms (Colosi et al., Journal of the American Chemical Society (2006) 128:4041-4047), but the experiments to be discussed below in FIGS. 2 and 3 revealed that laccase inactivation was much slower. Laccase still retained significant activity after reactions for 3 days in aqueous phase and 45 days in soil slurry, while earlier studies had shown that peroxidases lost their activities quickly after several hours of ECOHR in aqueous phase (Huang et al., Environmental Science & Technology (2002) 36:596-602 ; and Mao et al., Environmental Science & Technology (2009) 43:374-379). Second, laccase has wide industrial application, e.g. textile and paper and pulp, and are thus is readily commercially available in large quantity and reasonable price. Third, laccase uses oxygen as cofactor while peroxidases use hydrogen peroxide. As such, use of laccase in potential remediation practice would avoid the need of hydrogen peroxide addition. Therefore, further experiments focused on laccase.

In order to explore factors controlling PFOA degradation during laccase-mediated ECOHR, selected reaction systems were further characterized with regard to enzyme activity change and mediator degradation, and the results are shown in FIG. 2. As seen in FIG. 2, the laccase activity remained relatively stable during the 3 day reaction in all systems. The mediator 4-methoxyphenol diminished quickly during the first 2 hours of reaction, indicating the occurrence of ECOHR. It is known that laccase mediates the oxidative reaction of 4-methoxyphenol to form 4-methoxyphenyl free radical during ECOHR. The free radicals are highly reactive, which will couple to form dimer and polymers (Mao et al., Environmental Science & Technology (2009) 43:374-379) or react with PFOA to cause its degradation (Colosi et al., Environmental Toxicology and Chemistry (2009) 28:264-271). These dimers and polymers are still substrates of laccase that can undergo further ECOHR that may have contributed to the ensuing degradation of PFOA after the first few hours of reaction. FIG. 2B shows that 4-methoxyphenol concentration was reduced to 19.4% after 2 hours of reaction and further to 11.3% after 72 hours of reaction in the presence of 0.3 units/mL laccase. When laccase activity was increased to 10 units/mL, as shown in FIG. 2D, the reduction of 4-methoxyphenol concentration was 17.2% and 11.8% after 2 and 72 hours of reaction, respectively, not much different from the systems with 0.3 units/mL laccase. This suggests that laccase was used in excess with regard to mediator in these systems, and this may explain why no significant enhancement of PFOA removal was achieved by increasing enzyme dosages in these systems.

By comparing FIGS. 2A, 2B, and 2C, it may be seen that as the mediator concentration increased from 20 to 2000 μM in the presence of 0.3 units/mL laccase. PFOA removal was not enhanced much, although the absolute quantity of 4-methoxyphenol transformed during ECOHR increased nearly 100 fold. This suggests that there may be another unidentified factor that has limited the extent of PFOA degradation during ECOHR. Laccase consumes oxygen as cofactor during ECOHR, and in the experimental systems this was naturally dissolved oxygen without an extra supply, and the reactor was closed. Although the continued 4-methoxyphenol degradation in the experimental systems suggests the presence of oxygen, but it would have decreased over the course of ECOHR and thus limited the reaction rate. In addition, oxygen may not only serve as laccase cofactor in ECOHR systems but also directly participate in PFOA degradation. It has been suggested 4-methoxyphenol converts into 4-methoxyphenyl free radicals upon ECOHR and these free radicals attack PFOA, likely on the head C—C bond to abstract an electron, and turn PFOA into a free radical that can undergo further rearrangement and degradation (Colosi et al., Environmental Toxicology and Chemistry (2009) 28:264-271). An earlier study on electrochemical degradation of PFOA indicated that PFOA was turned into a free radical electrochemically, which then degraded through rearrangements, and that oxygen was involved in this process and incorporated in the products (Zhuo et al., Environmental Science & Technology (2011) 45:2973-2979). As such, consumption of oxygen during ECOHR may not only limit laccase activity, but may also limit the rearrangement and degradation process of PFOA free radicals.

The experimental results indicate that all three enzymes are capable of mediating ECOHR to cause PFOA degradation under appropriate conditions. Laccase is a promising candidate for potential remediation use because of its stability and availability. The level of oxygen may be a factor that influences PFOA degradation during ECOHR, in addition to laccase dosage and mediator concentration. The use of isotope-labeled oxygen in combination with product identification may help with exploring the role of oxygen in PFOA degradation. Further study on product identification may help in understanding PFOA degradation mechanisms during ECOHR and possible product toxicity. A combination of mass spectrometry and chemical oxidation technology as well as high resolution mass spectrometry and nuclear magnetic resonance may be useful in product identification.

### Example 2

### Batch Reactor System: Soil Slurry

Experiments were also conducted to examine both PFOA and PFOS degradation during laccase-mediated ECOHR in soil slurry. These experiments were done because the reaction behavior of ECOHR may be very different between aqueous phase and soil slurry. This is because soil may interact with the enzyme, PFOA, and the mediator, which would thus influence the interactions among the three factors and in turn change ECOHR dynamics Thus, understanding the influence of the presence of soil on PFC degradation during ECOHR can help the effective use of ECOHR in groundwater remediation.

Incubation experiments were conducted with sterilized soil containing PFOA or PFOS in the presence of laccase and different mediators. Before each incubation experiment, the soil was sterilized by incubation twice (24 hours each time) and autoclaved three times (60 minutes each time) at 121° C. over a three day period. To prepare PFOA or PFOS contaminated soil samples, 100 g of soil was spiked with PFOA or PFOS stock solution in methanol, which was then left uncovered under a fume hood with vigorous mixing to evaporate solvent and yield a sample containing 10 μg PFOA g⁻¹ soil or 5 μg PFOS g⁻¹ soil. Properties of the soil used in this study are given in Table 2.

TABLE 2
Properties of the tested soil.

| Parameter | Value |
|---|---|
| Sand content (%) | 66.00 |
| Silt content (%) | 23.60 |
| Clay content (%) | 10.40 |
| pH | 5.15 |
| Cation exchange capacity (meq/100 g) | 3.70 |
| Organic matter content (%) | 2.90 |
| Soluble salts (mmhos/cm) | 0.04 |
| Base saturation (%) | 65.93 |

The incubation was conducted in 50 mL polypropylene centrifuge tubes. Each tube contained 1 g soil (preloaded with 10 μg PFOA or 5 μg PFOS) and 1.5 mL distilled deionized water. Laccase was added to the system at 2 unit g⁻¹ soil every 48 hours. One of the three mediators violuric acid (VA), 1-hydroxybenzotriazole (HBT), and 2,2′-azino-bis(3-ethylbenzothiazoline-6-sulphonic acid) (ABTS) was added along with laccase each time. Equal amounts of mediator were added each time, and the total amount added was either 4 or 8 μmole over the entire incubation period. Control systems were also prepared without laccase or mediator. All tubes were placed in the dark throughout the experiment, with openings covered with paraffin film to allow exchange of oxygen while restricting water evaporation. The contents of each tube were thoroughly mixed on a mechanical shaker at the beginning of the incubation, and then mixed manually twice a day during the entire incubation period. The paraffin film was left open for an hour after each mixing to allow sufficient re-aeration. At pre-selected time intervals, triplicate tubes were sampled for PFOA and PFOS analysis. To this end, the samples were first frozen at −18° C. and then freeze dried (Labconco freeze drier) for further extraction of PFOA and PFOS from soil as described below.

To extract PFOA from the soil, the soil in each reactor, after being freeze dried as mentioned above, was mixed with a 5 mL mixture of dichloromethane and methanol (2:1, V:V), ultrasonicated for 30 minutes, and then centrifuged for 30 minutes at 250 G. This extraction procedure was repeated once. Supernatant from both extractions was combined and then dried to 1 mL under a gentle nitrogen flow. The solution was then loaded onto a silica solid-phase extraction (SPE) cartridge (Restek, 6 mL, 1000 mg) that was preconditioned with 5 mL of hexane. After loading, the cartridge was eluted with 20 mL of hexane and air dried for 5 minutes for cleanup. The cartridge was then eluted with 5 mL acetonitrile, with the eluent collected, blown dry by a nitrogen flow, and finally reconstituted to 1.0 mL with acetonitrile for PFOA or PFOS quantification on LC-MS/MS using the same method described herein above.

FIG. 3 displays the recovery of applied PFOA (%) from the laccase-treated soil samples after 15 or 45 days of incubation. PFOA recovery in the control system (without laccase or mediator added) was near 85% and consistent, reflecting the robustness of the analytical procedure. Note that PFOA recovery in laccase-treated samples (without added mediator) was 70.2 and 65.6% after 15 and 45 days of incubation, respectively, which are much lower than the control systems. This indicates that PFOA was transformed during laccase-mediated ECOHR even without a mediator added. It is known that PFOA is not a direct substrate of laccase, and its transformation occurs via a mediator-assisted mechanism (Colosi et al., Environmental Toxicology and Chemistry (2009) 28:264-271). Such a mediator, typically a phenolic chemical, reacts with humification enzymes to generate a free radical that can in turn attack PFOA. The fact that PFOA was transformed in laccase-mediated soil slurry without an added mediator may suggest that the organic matter in soil (or dissolved from soil) can serve the role of mediator and induce PFOA transformation during ECOHR. There have been reports that soil organic matter contains rich phenolic functionalities that can react with humification enzymes (Piccolo et al., Naturwissenschaften (2000) 87:391-394).

FIG. 3 also shows that PFOA recovery in laccase-treated soil was significantly reduced when a mediator was added. This suggests the importance of mediator and corroborates the idea that PFC is transformed in ECOHR via a mediator-assisted mechanism. For laccase-VA, laccase-HBT, and laccase-ABTS systems, the values of PFOA recovery was 11.6, 27.7, and 19.9% for 15 day incubation, and 9.9, 1.6, and 5.3% for 45 day treatment, respectively. The extents of PFOA removal were significantly greater than those obtained in aqueous phase experiments as shown in Table 1 and FIG. 1. Although the reaction conditions were not directly comparable between the aqueous phase and soil slurry experiments, the presence of soil may have played a role to facilitate ECOHR and PFOA degradation. One phenomenon that was observed is that enzyme inactivation was mitigated in soil slurry. In a test it was observed that near 50% laccase activity remained after 45 days of ECOHR in soil slurry. It is possible that the laccase may be sorbed on soil, and thus be protected from inactivation. There have been reports that sorption of humification enzymes on support media effectively mitigates enzyme inactivation (Eichlerová et al., Chemosphere (2012) 88:1154-1160). Further, the soil may also effectively sorb PFOA and the mediators in addition to the enzyme, and thus all ECOHR factors would be concentrated on soil surface, which might have facilitated ECOHR through a “micro-reactor” effect.

FIG. 4 compares PFOA recovery after 15 day incubation with each of the three mediators added at two different dosages, 4 or 8 micromole g⁻¹ soil. At the lower mediator dosage (4 micromole g⁻¹ soil), PFOA recovery in laccase-VA, laccase-HBT, and laccase-ABTS systems was 34.8, 42.1, and 41.8% respectively, while at 8 micromoles g⁻¹ soil, the values were 11.6, 27.7, and 19.9%. The dependence of PFOA removal on mediator dosage is evident with higher mediator dosage corresponding to lower PFOA recovery. This seems to differ from what was observed for the aqueous phase shown in FIG. 1, where an increase of mediator concentration from 20 to 2000 μM had little impact on PFOA removal. Note that in the soil slurry experiment, paraffin film was used to cover the reaction vessels and it was left open periodically to allow sufficient re-aeration; in contrast, the reactors in the aqueous phase experiment were capped throughout the experiment. Thus, a limited oxygen supply might have limited PFOA removal in the aqueous phase experiment, and that when this limitation factor was alleviated in the soil slurry experiment, the effect of mediator concentrations became evident.

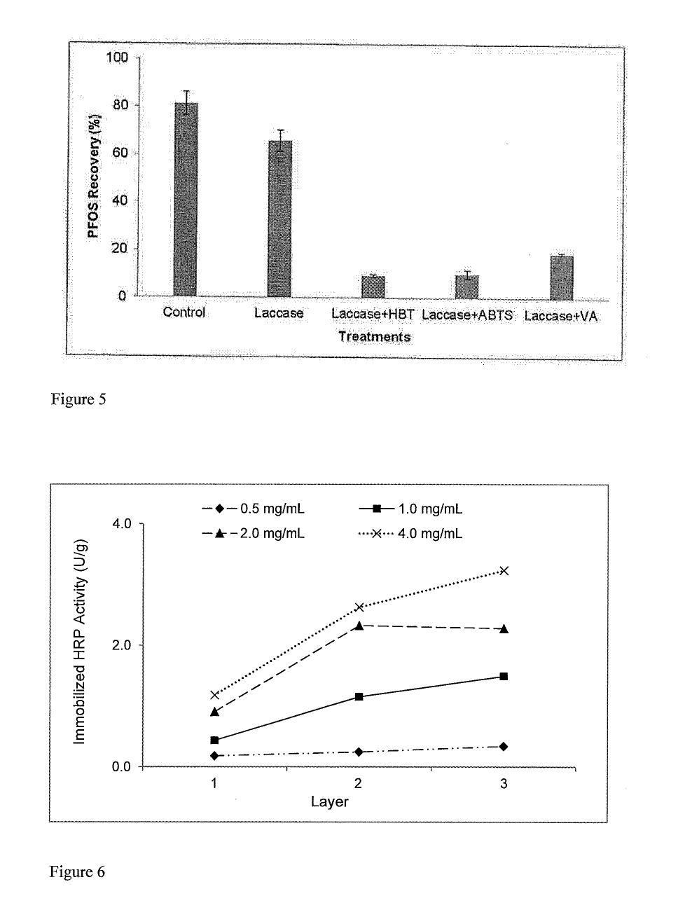

FIG. 5 displays the recovery of applied PFOS (%) from the laccase-treated soil samples after 15 days of incubation. PFOS recovery in the control system (without laccase or mediator added) was 81.4%, while that in the laccase-treated samples (without added mediator) was reduced to 65.8%. When a mediator was added, PFOS recovery was further reduced to 17.8, 9.1, and 10.0% in laccase-VA, laccase-HBT, and laccase-ABTS systems. This is a strong indication of PFOS transformation in ECOHR. All earlier reports on PFC degradation were focused on PFOA and the data here is the first set showing PFOS degradation, which is significant and encouraging. It is also important to note that PFOS, like PFOA, degrades in laccase-treated systems without an added mediator. This suggests that soil organic matter can serve the role of mediator in ECOHR to induce the degradation of both PFOA and PFOS. It is of practical significance to further examine this and explore whether PFC degradation may be accelerated by adding natural organic matter.

The experiments have shown that both PFOA and PFOS were degraded significantly in soil via laccase-mediated ECOHR. It seems that soil organic matter can serve the role of mediator for ECOHR to cause PFC degradation, and that the reaction was enhanced when chemical mediators were added. It appears that the presence of soil in the system plays a synergetic role in ECOHR, which warrants further investigation in future studies. Soil may sorb laccase and protect it from inactivation, thus leading to prolonged catalytic activity. All ECOHR factors, including the mediator, the enzyme, and PFOA, may be concentrated on soil surface via sorption, which may enhance the reaction by a “micro-reactor” effect.

### Example 3

### Enzyme Immobilization

Several approaches have been studied, including layer-by-layer assembly, covalent bonding and adsorption, to immobilize two humification enzymes, horseradish peroxidase (HRP) and laccase, onto the surface of various support media. Quartz sand, soil, clay, and activated carbon were used as the support media. Suitable immobilization conditions for different enzymes and immobilization methods have been identified. The goal was to develop approaches for preparing enzyme-loaded solid medium that can be used in the PRB to induce ECOHR for PFC remediation.

### Enzyme Immobilization: Layer-By-Layer Assembly Approach

The layer-by-layer assembly approach for enzyme immobilization is based on the strategy of alternately depositing layers of oppositely charged polyelectrolytes or enzymes on the support medium surface (Caruso et al., Langmuir (2000) 16:9595-9603; and Huang et al., Environmental Science & Technology (2008) 42:8884-8889). These layers were held strongly together through electrostatic interactions. This approach was tested on sand as a model support medium and the procedure is briefly described below.

Prior to the assembly of polyelectrolyte multilayers, sands were cleaned up by RCA (Radio Corporation of America) procedure with 5:1:1 (vol) H₂O/H₂O₂/HCl mixture at 70° C. for 10 minutes followed by 10 minutes of immersion in 5:1:1 (vol) H₂O/H₂O₂/NH₄OH solution at 70° C. The assembly involved alternate deposition of polyelectrolytes and the charged enzyme on treated sand. Each sorption step was carried out in a separate solution with pH deliberately adjusted to render the polyelectrolytes or the enzyme having appropriate charges. Each sorption step led to a reversal of the terminal surface charge after adsorption of a new layer. Following a conventional layer-by-layer method, poly(allylamine hydrochloride) (PAH) and poly(sodium 4-styrenesulfonate) (PSS) were used as the polyanions and polycations, respectively (Caruso et al., Langmuir (2000) 16:9595-9603; and Huang et al., Environmental Science & Technology (2008) 42:8884-8889). Both chemicals were prepared at a concentration of 100 mg/mL in 0.05 M sodium acetate buffer at pH 4.5. The pH of the enzyme solution was adjusted to several units away from their isoelectric points (pI_{laccase}=3.7, pI_{HRP}=8.8) to maintain a net negative or positive charge. Sequential polyelectrolyte/enzyme layers were deposited to form repetitive sand-PAH-PSS-enzyme or sand-PAH-PSS-PAH-enzyme sandwich assemblies. For each assembly step, different concentrations of polyelectrolyte/enzyme solution were allowed to equilibrate with the sand particles for 20 minutes and 2 hours for polyelectrolyte and enzyme, respectively, at different temperatures.

### Enzyme Immobilization: Covalent Bonding Approach

The covalent binding approach for enzyme immobilization first involved activation to attach reactive functional groups on the support medium surface, followed by covalent bonding to tether the enzymes under appropriate reaction conditions (Fernández-Fernández et al., Biotechnology Advances (2012) dx.doi.org/10.1016/j.biotechadv.2012.02.013; Sarkar et al., Soil Biology and Biochemistry (1989) 21:223-230; and Yang et al., Journal of Biotechnology (2010) 148:119-127). This approach was tested on sand, soil, and clay as model support media, and the procedures are described briefly below.

Sand. 10 g of sand was mixed with 50 mL of 2% chitosan solution and stirred for 1 hour, then rinsed with deionized (DI) water several times. The chitosan coated sands were then treated with 10% of gultaraldehyde and continuously stirred for 2 hours. The sands were collected and rinsed with DI water and dried in the oven. 1 g of pretreated sand was mixed with 5 mL of an enzyme solution that contained 0.5% gultaraldehyde at different dosages and pH, and stirred for 2 hours at various temperatures.

Soil and clay. The soil with properties as displayed in Table 2, and the clay kaolinite were used in this study. 1 g soil or clay was treated with concentrated HNO₃ and boiled for 1 hour. Then the pellet was rinsed with DI water several times until the pH of the rinse water reached 6.0. To activate the support medium, the pretreated soil or clay was immersed in 2% solution of 3-aminopropyltriethoxysilane (APTES) in acetone. The activated support medium was then treated with 5 mL of 5% glutaraldehyde dissolved in 100 mM phosphate buffer (pH 7.0). The mixture was then evacuated for 1 hour, washed several times with DI water, and then washed with 100 mM pH 7.0 phosphate buffer. The enzyme was prepared in different pH buffers to make 100 unit/mL solutions which were mixed with the activated support medium, and the mixture was incubated at 4° C. for 36 hours with occasional shaking for enzyme immobilization.

### Enzyme Immobilization: Adsorption Approach

Certain solid support media can strongly adsorb enzymes via non-specific physical interactions, which could also lead to effective enzyme immobilization. This approach was tested on granular activated carbon (GAC).

Batch adsorption experiments were carried out in 125 mL conical flasks by mixing 50 mg of granular activated carbon (20-40 mesh) with 10 mL of an enzyme solution at different dosages. The mixture was incubated on an incubator shaker operated at a constant agitation speed of 125 rpm at 25° C. for 72 hours, which was sufficiently long to attain equilibrium as verified in preliminary tests. After incubation, the solution phase and solid phase were separated by centrifugation. The laccase activity remaining in solution before and after the adsorption was quantified by spectrometry described below.

### Enzyme Activity Assessment

HRP activity was assayed by measuring the color change of ABTS. In this method 0.05 mL of an enzyme solution sample was added to a 3 mL of reaction mixture containing 2 mM ABTS in phosphate buffer (pH 6.0). This was followed by addition of 0.3 mL of 10 mM H₂O₂ to the mixture and the absorbance was measured at 405 nm on a Du 640-B spectrophotometer (Beckman Instruments, Inc.). One unit of peroxidase activity was defined as the amount of HRP to catalyze the oxidation of one μmol of ABTS per minute. Laccase activity was determined spectrometrically by oxidation of 1 mM of 2,6-dimethoxyphenol in citrate phosphate buffer (pH 3.8), the absorbance of which was measured at 468 nm. One unit of laccase activity was defined as the amount of laccase that causes a unit change per minute in absorbance at 468 nm in 3 4 mL of this solution in a cuvette with a 1 cm light path. When assessing the activity of an enzyme immobilized on a support medium, the enzyme-loaded solid sample was collected, washed thoroughly with DI water until no further activity was present in the rinse. 10 mg of the solid sample was used for activity assessment using the same methods described above, except that the assay solution was shaken during the incubation and centrifuged before absorbance measurement.

### Results and Discussion: Layer-By-Layer Approach

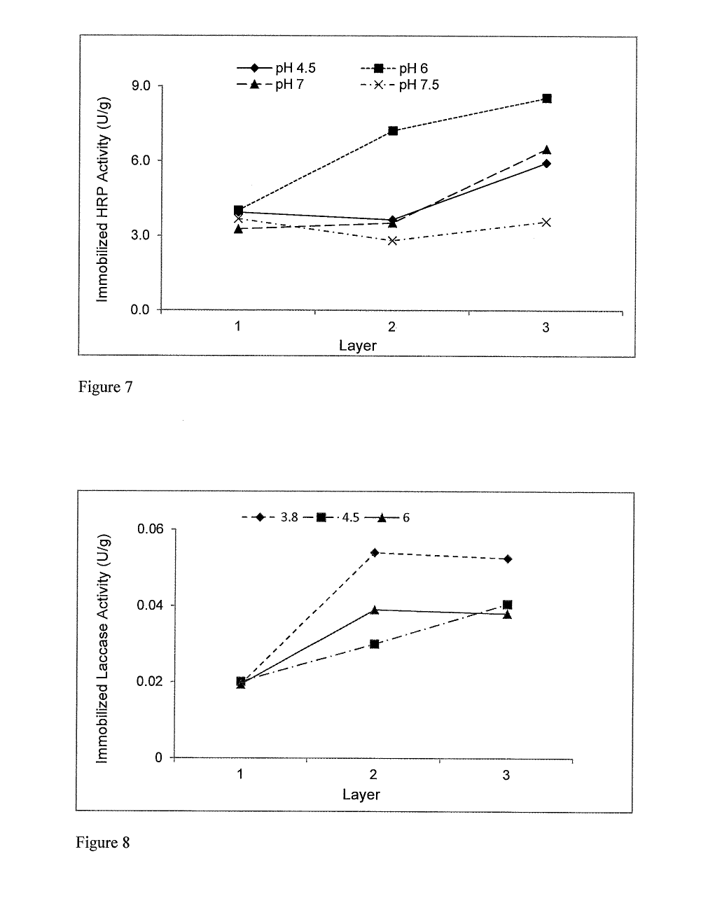

FIG. 6 presents the results of HRP immobilization when different concentration of HRP solution was used in the layer-by-layer assembly procedure. FIG. 7 shows the results of HRP immobilization when the HRP solution was adjusted to a different pH. Typically, the activity of immobilized HRP increased as more enzyme layers were assembled on the support surface. As seen in FIG. 6, higher HRP activity was immobilized when higher concentration of the enzyme solution was used in assembly. As shown in FIG. 7, immobilized HRP activity increased when the immobilization pH rose from 4.5 to 6, but it dropped sharply when the immobilization pH was around 7.5 (FIG. 7), likely due to the pH being closer to the pI_{HRP} (pH 8.8), and thus the HRP did not become fully charged. The results for laccase immobilization are shown in FIG. 8. The immobilized laccase activity also increased with increasing numbers of enzyme layers. Elevation of immobilized laccase activity was observed with decreased pH. However, the immobilization efficiency for laccase was quite low, at only 0.054 unit/g sand under these conditions. This indicated that the layer-by-layer approach is not a preferred option for laccase immobilization.

### Results and Discussion: Covalent Bonding Approach

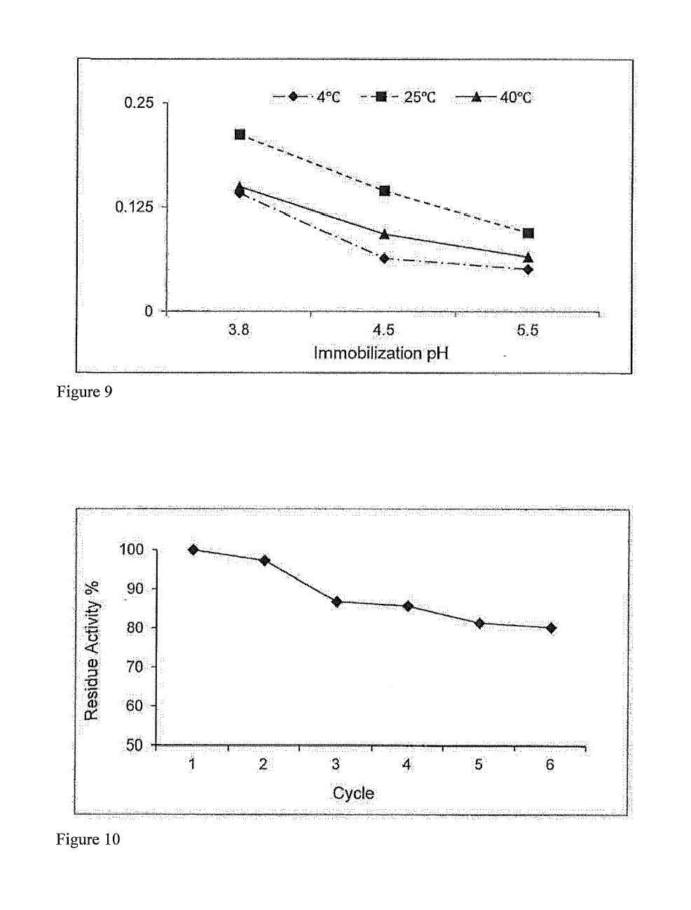

The impact of immobilization temperature and pH on laccase immobilization on sand via covalent bonding was shown in FIG. 9. The highest immobilization was achieved when the immobilization was carried out at pH 3.8, which is the apparent optimum pH for free laccase. A suitable temperature for laccase immobilization was 25° C., with higher (40° C.) or lower (4° C.) temperatures leading to decreased laccase immobilization. The reusability of the immobilized laccase prepared via covalent bonding (FIG. 10) was tested. Nearly 80% of the activity remained after 6 reaction cycles, indicating the stability of the sand-immobilized enzyme by covalent bonding.

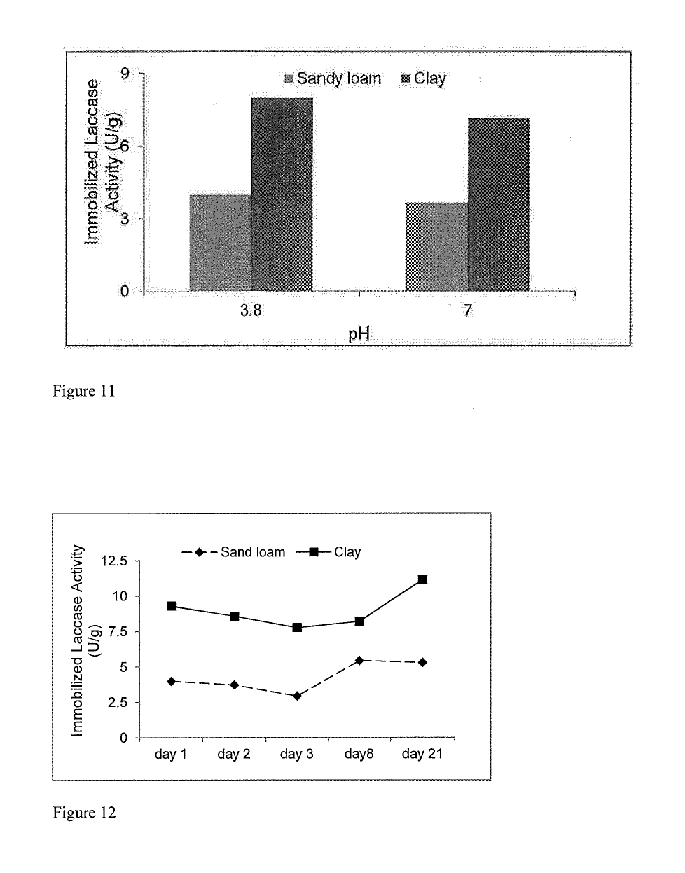

FIG. 11 depicts immobilized laccase activities on a sandy loam soil and the clay kaolinite under different immobilization pHs. The immobilized laccase activities onto the sandy loam soil and the clay were significantly higher than on sand. The immobilized activities at suitable immobilization conditions were 3.98 unit/g on the soil and 7.91 unit/g on the clay. The effective laccase immobilization on soil may be attributable to its clay contents. The immobilized laccase activity when immobilized at pH 3.8 was greater than when immobilized at pH 7.0. Apparently, an optimum immobilization pH for laccase is close to the apparent optimum pH of free laccase. The stability of laccase immobilized on soil and clay were also investigated (FIG. 12). Over 21 days, the laccase immobilized on soil or clay did not lose much activity. Based on the above data, covalent bonding appeared to be an efficient and reliable approach to immobilize the laccase on soil and clay.

### Results and Discussion: Adsorption

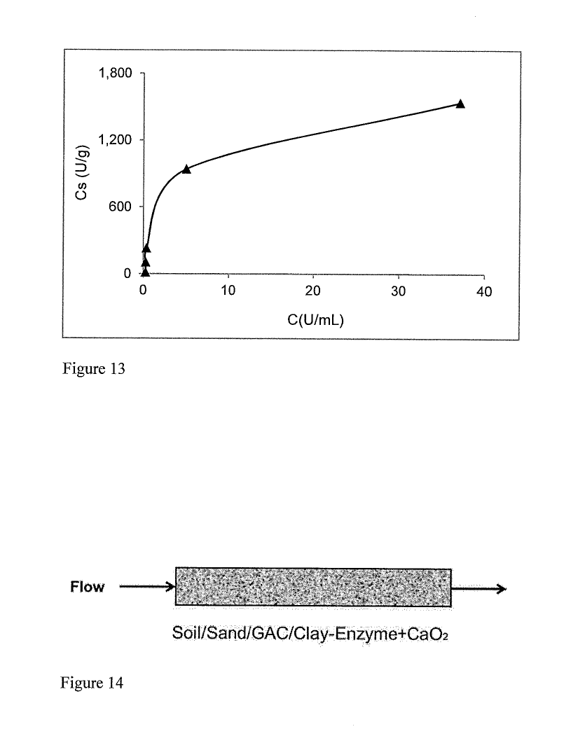

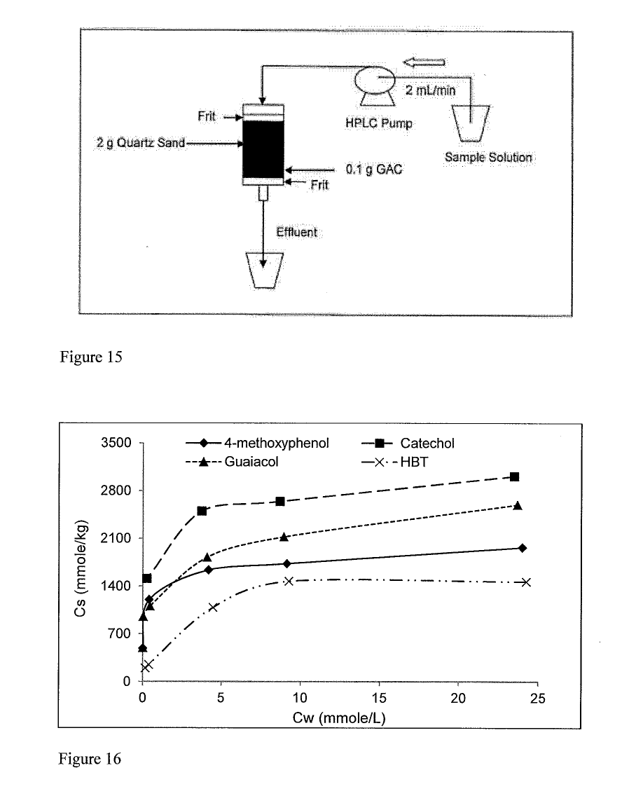

The sorption isotherm of laccase on activated carbon is shown in FIG. 13. When the laccase activity in aqueous phase was 0.35 U/mL, the activity adsorbed on GAC achieved 230 U/g. The immobilization efficiency is very high, more than the other immobilization methods and carriers that have been tested. Besides, adsorption approach is relatively simple and inexpensive, therefore having great potential in remediation applications.

In summary, sand did not seem to be a good support medium for immobilizing humification enzymes, perhaps because of its limited specific surface area. On the contrary, soil and clay seemed to be good support media. The good immobilization achieved on soil was probably attributable to its clay content. Adsorption led to effective immobilization of laccase on GAC, making a great option for potential remediation applications. Laccase adsorption on other materials of application potential such as clay, diatom earth, and different types of soils, as well as laccase immobilization by covalent bonding on GAC, different clays and other materials, may also provide useful results.

### Example 4

### Column System

A double-layer permeable reactive barrier (DL-PRB) system was originally proposed as shown in FIG. 1, for inducing in-situ ECOHR reactions. The DL-PRB includes an oxidant-releasing material layer followed by a layer of quartz sand immobilized with humification enzymes. The idea evolved based on the batch study and the enzyme immobilization study results discussed above. First, sand may not the best candidate for enzyme immobilization to be used in the reactive barrier. Instead, GAC, clay, or soil, individually or combined, may be better materials for immobilizing enzymes and used in the reactive barrier. Sand may also be mixed in the barrier to adjust flow condition. Second, the oxygen releasing material, such as calcium peroxide, may not have to be a separate layer prior to the reactive layer, but can be directly mixed in the reactive barrier. The evolved conceptual model is schematically represented in FIG. 14. A laboratory column study was conducted to examine POFA breakthrough on a column packed with GAC immobilized with laccase through adsorption. In order to design this column study, adsorption isotherms of PFOA and a few mediators on GAC was also investigated.

### Sorption Isotherms

Batch sorption experiments were carried out at 25° C. by mixing granular activated carbon (GAC) with a chemical solution under consistent shaking at 225 rpm. The sorption isotherms of four mediators, including 4-methoxyphenol, guaiacol, catechol, and HBT were tested. In these experiments, 10 mg of GAC was mixed with 20 mL of the mediator solution at concentrations ranging from 0.25 mM to 25 mM. After 48 hours of mixing, which was adequate to achieve equilibrium based on preliminary study, 2 mL of the sample was taken and then centrifuged. The supernatant was then transferred to HPLC vial for analysis. The sorption isotherm experiment for PFOA was conducted in 250 mL polyethylene bottles that contained 10 mg GAC and 100 mL of HPLC water spiked with PFOA at concentrations ranging from 1 mg/L to 80 mg/L. The mixtures were continuously agitated on an incubator shaker for 7 days. At pre-selected time intervals, samples were taken from a mixture and set still for 1 hour to allow phase separation, and the supernatants were sampled for HPLC analysis.

### Column Study

The setup of the flow-through column experiment is schematically represented in FIG. 16. First, laboratory-scale columns packed with 0.1 g GAC and 2 g quartz sand were prepared for the flow-through column experiment. The 2 mL micro-column fitted with a porous polyethylene frit on one end was first wetted with HPLC water and then filled with 0.1 g GAC that had been saturated with HPLC water prior to filling. The column was periodically tapped and the water level in the column was maintained above the solid fillings through the packing process to ensure packing quality. On top of this GAC layer, 2 g wetted sand was filled using the same approach, and then another frit was fitted on top of the sand layer to secure the packed beds. After packing, the column was flushed with HPLC water at 1 mL/minute for 10 hours before use. In order to preload laccase to the packed column, 42 mL of a 1.0 unit/mL laccase solution was passed through the column using a syringe pump, and laccase activity in the effluent was measured at selected time points. For a PFOA flow-through experiment, a mixture solution containing 0.06 mg/L PFOA, 0.15 mM of HBT, and 1 unit/mL laccase was continuously passed through the column at a flow rate of 2 mL/minute using a Waters HPLC pump. HBT was used as the co-substrate to mediate ECOHR, and the concentrations were selected based on isotherm and batch studies. The effluent was collected at pre-selected time intervals in conical flask and acidified with a 1M HCl solution to stop ECOHR. A blank control column was also prepared in which laccase was not pre-loaded, and the solution used in the flow-through experiment contained only 0.06 mg/L PFOA without laccase or HBT. A total of 15 L solution was passed through the column and the procedure lasted about 6 days. Selective effluent samples were concentrated by passing through Waters Oasis HLB cartridges and eluted with methanol, and the eluent was collected and saved for LC-MS/MS analysis to quantify PFOA and HBT.

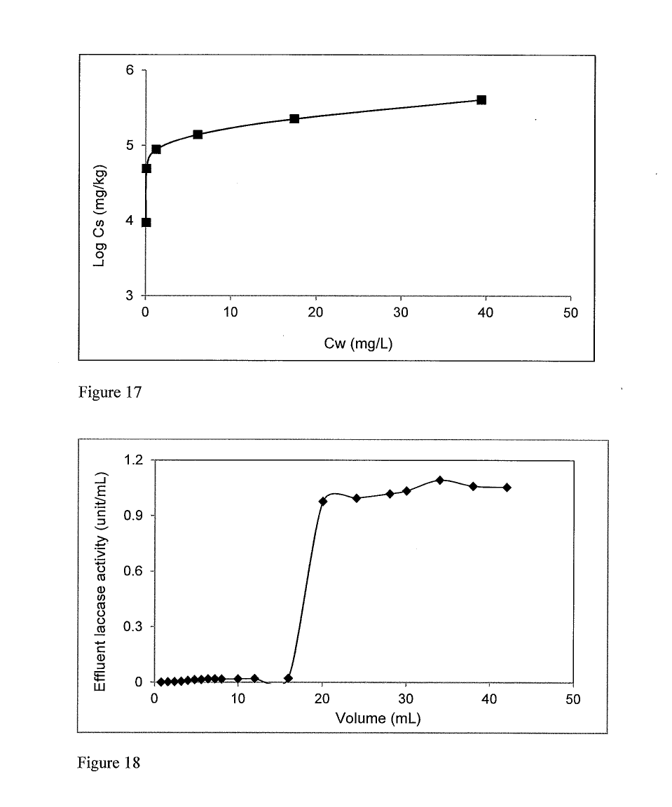

The sorption isotherms of 4-methoxyphenol, guaiacol, catechol, and HBT on GAC are displayed in FIG. 16, and all exhibited favorable strong sorption. To facilitate comparison, the solid phase concentrations of the chemicals when their aqueous phase concentration were near 4 mM are 2500, 1823,1638, and 1085 mmole/Kg for catechol, guauacol, 4-methoxyphenol, and HBT, respectively. The sorption isotherm of PFOA on GAC is shown in FIG. 17, and its sorption is much stronger than the other four chemicals. When the aqueous concentration of PFOA is near 1 mg/L, the solid phase concentration is about 100,000 mg/Kg. The sorption isotherm of laccase on GAC is shown in FIG. 13. Based on these sorption isotherm data, the concentration levels of the PFOA (0.067 mg/L), the mediator HBT (0.15 mM), and laccase (1 unit/L) for the feed solution in the flow-through column experiment were selected. These correspond to equilibrium solid phase concentrations of 9.37 mg/g, 196 mmole/Kg, and 477 unit/g, for PFOA, HBT, and laccase, respectively.

FIG. 18 shows the laccase activity in the effluent over time during the laccase-preloading procedure by passing a 1.0 unit/L laccase solution through the GAC-packed column. A typical breakthrough curve was obtained and the breakthrough occurred when about 20 mL solution had passed, corresponding to about 20 units laccase being retained in the 0.1 g GAC packed column, assuming that the sand does not sorb laccase. The well-shaped laccase breakthrough curve also indicated the good quality of the column packing.

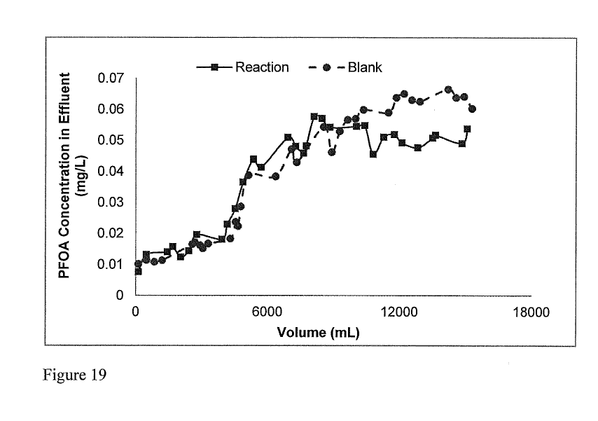

A flow-through column experiment was conducted, as described in the Experiments, to compare a reaction system in which laccase was pre-loaded to the column and the feed solution contained PFOA, HBT, and laccase, and a blank control system in which laccase was not pre-loaded and the feed solution only contained PFOA. As shown in FIG. 19, the breakthrough on the reaction column seemed to occur slightly earlier than the blank column, but clearly has the PFOA concentration in the effluent reduced. The enzyme and mediator present in the feed solution for the reaction column may have reduced PFOA sorption on GAC that may have contributed to the quicker PFOA breakthrough on the reaction column. The maximum PFOA concentration in the effluent from the blank column was 0.0664 mg/L while that from the reaction column was 0.0576 mg/L. A calculation based on the breakthrough curve shown in FIG. 19 yields the solid phase concentration on the blank and reaction columns were 3.37 and 2.52 mg/g, respectively, representing nearly 25% reduction on the reaction column than the blank column. Note that the column experiment lasted only about 6 days and more reduction may be achieved by longer contact time or by optimizing the conditions to facilitate ECOHR. The breakthrough data in FIG. 19 strongly suggest the promising potential of using ECOHR in a permeable reactive barrier (PRB) setup to remove PFOA in groundwater.

In summary, PFOA, the mediators, and laccase all adsorbed strongly on GAC, making it a promising candidate material to be used in PRB to induce ECHOR for PFC remediation. ECHOR may be enhanced on GAC surface through micro-reactor effects because all factors are concentrated through sorptions. The data from column study strongly suggests the promising potential of using ECOHR in PRB for PFCs remediation in soil/groundwater.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. An in situ method for at least partially remediating soil and/or groundwater containing perfluroroalkyl compounds (PFCs), the method comprising amending an effective amount of one or more catalysts that mediate enzyme-catalyzed oxidative humification reactions (ECOHRs) into the soil and/or groundwater.

2. The method of claim 1 wherein the perfluroroalkyl compounds (PFCs) comprise perfluorocarboxylic acids, perfluorosulfonic acids, polyfluorinated telomers, or combinations thereof.

3. The method of claim 1 wherein the one or more catalysts that mediate enzyme-catalyzed oxidative humification reactions (ECOHRs) comprise one or more of laccase, horseradish peroxidase, lignin peroxidase, manganese peroxidase, a manganese oxide, and an iron oxide.

4. The method of claim 1 wherein the method further comprises amending an effective amount of one or more cofactors into the soil and/or groundwater.

5. The method of claim 4 wherein the one or more cofactors comprise a source for hydrogen peroxide and/or oxygen.

6. The method of claim 5 wherein the source comprises calcium peroxide.

7. The method of claim 1 wherein the method further comprises amending an effective amount of one or more enzyme-catalyzed oxidative humification reaction (ECOHR) mediators into the soil and/or groundwater.

8. The method of claim 7 wherein the one or more enzyme-catalyzed oxidative humification reaction (ECOHR) mediators comprise one or more of violuric acid (VA), 2,2′-azino-bis(3-ethylbenzothiazoline-6-sulphonic acid (ABTS), 1-hydroxybenzotriazole (HBT), 2,4-dimethoxyphenol, 4-methoxyphenol, guaiacol, and catechol.

9. The method of claim 1 wherein the one or more catalysts are immobilized on soil, sand, clay, and/or activated carbon.

10. The method of claim 1 wherein amending comprises soil blending, soil mixing, or direct injection into groundwater.

11. A method for at least partially remediating soil and/or groundwater containing perfluroroalkyl compounds (PFCs), the method comprising amending an effective amount of an oxidase into the soil and/or groundwater.

12. The method of claim 11 wherein the oxidase comprises laccase.

13. The method of claim 11 wherein the perfluroroalkyl compounds (PFCs) comprise perfluorocarboxylic acids, perfluorosulfonic acids, polyfluorinated telomers, or combinations thereof.

14. The method of claim 11 wherein the method further comprises amending an effective amount of one or more enzyme-catalyzed oxidative humification reaction (ECOHR) mediators into the soil and/or groundwater.

15. The method of claim 14 wherein the one or more enzyme-catalyzed oxidative humification reaction (ECOHR) mediators comprise one or more of violuric acid (VA), 2,2′-azino-bis(3-ethylbenzothiazoline-6-sulphonic acid (ABTS), 1-hydroxybenzotriazole (HBT), 2,4-dimethoxyphenol, 4-methoxyphenol, guaiacol, and catechol.

16. The method of claim 11 wherein the method is an in situ method or an ex situ method.

17. The method of claim 11 wherein the oxidase is immobilized on soil, sand, clay, and/or activated carbon.

18. The method of claim 11 wherein amending comprises soil blending, soil mixing, or direct injection into groundwater.

19. A method for at least partially remediating soil and/or groundwater containing perfluroroalkyl compounds (PFCs), the method comprising amending into the soil and/or groundwater components comprising:
an effective amount of one or more catalysts that mediate enzyme-catalyzed oxidative humification reactions (ECOHRs); and
an effective amount of one or more enzyme-catalyzed oxidative humification reaction (ECOHR) mediators selected from the group consisting of violuric acid (VA), 2,2′-azino-bis(3-ethylbenzothiazoline-6-sulphonic acid (ABTS), 1-hydroxybenzotriazole (HBT), 2,4-dimethoxyphenol, 4-methoxyphenol, guaiacol, and catechol.

20. The method of claim 19 wherein the perfluroroalkyl compounds (PFCs) comprise perfluorocarboxylic acids, perfluorosulfonic acids, polyfluorinated telomers, or combinations thereof.

21. The method of claim 19 wherein the one or more catalysts that mediate enzyme-catalyzed oxidative humification reactions (ECOHRs) comprise one or more of laccase, horseradish peroxidase, lignin peroxidase, manganese peroxidase, a manganese oxide, and an iron oxide.

22. The method of claim 19 wherein the method further comprises amending an effective amount of one or more sources for hydrogen peroxide and/or oxygen into the soil and/or groundwater.

23. The method of claim 19 wherein the method is an in situ method or an ex situ method.

24. The method of claim 19 wherein the one or more catalysts are immobilized on soil, sand, clay, and/or activated carbon.

25. The method of claim 19 wherein amending comprises soil blending, soil mixing, or direct injection into groundwater.

26. A composition comprising one or more catalysts that mediate enzyme-catalyzed oxidative humification reactions (ECOHRs) immobilized on soil, sand, clay, and/or activated carbon.

27. The composition of claim 26 wherein the one or more catalysts that mediate enzyme-catalyzed oxidative humification reactions (ECOHRs) comprise one or more of laccase, horseradish peroxidase, lignin peroxidase, manganese peroxidase, a manganese oxide, and an iron oxide.

28. The composition of claim 26 wherein the one or more catalysts are immobilized utilizing adsorption, electrostatic interactions, and/or covalent bonding.

29. A system for at least partially remediating soil and/or groundwater containing perfluroroalkyl compounds (PFCs) comprising at least a first layer of an enzyme-catalyzed oxidative humification reaction (ECOHR) barrier comprising an effective amount of a composition according to claim 26.

30. The system of claim 29 further comprising a second layer comprising an effective amount of an oxidant-releasing material layer.
